(19) United States
(12) Patent Application Publication
(10) Pub. No.: US 2023/0222639 A1
(43) Pub. Date: Jul. 13, 2023

(54) DATA PROCESSING METHOD, SYSTEM, AND APPARATUS

(71) Applicant: Huawei Technologies Co., Ltd., Shenzhen (CN)

(72) Inventors: Xinyu ZHANG, Shenzhen (CN); Bing YU, Shenzhen (CN); Zhao ZHONG, Beijing (CN)

(21) Appl. No.: 18/182,655

(22) Filed: Mar. 13, 2023

Related U.S. Application Data
(63) Continuation of application No. PCT/CN2021/115085, filed on Aug. 27, 2021.

(30) Foreign Application Priority Data
Sep. 14, 2020 (CN) 202010959989.4

(51) Int. Cl. G06T 5/50; G06T 7/00; H04N 23/84

(52) U.S. Cl. CPC G06T 5/50; G06T 7/0002; H04N 23/84; G06T 2207/10024; G06T 2207/20081; G06T 2207/30168

(57) ABSTRACT

This application provides a data processing method, system, and apparatus, and relates to the field of artificial intelligence (AI). The data processing method may be performed by a server, or may be performed by a device having a data processing function. During execution, reference data is first obtained. The reference data includes RGB image data and a device parameter of an image device. Then, a plurality of conversion parameters required for converting the RGB image data into RAW data are determined. Finally, the RGB image data is processed into the RAW data based on the plurality of conversion parameters. The RAW data matches the device parameter of the image device. In this application, the RGB image data is converted into the RAW data based on the plurality of conversion parameters rather than manual experience. Therefore, the described data processing method, system, and apparatus improve data processing efficiency.

### CROSS-REFERENCE TO RELATED APPLICATIONS

This application is a continuation of International Application No. PCT/CN2021/115085, filed on Aug. 27, 2021, which claims priority to Chinese Patent Application No. 202010959989.4, filed on Sep. 14, 2020. The disclosures of the aforementioned applications are hereby incorporated by reference in their entireties.

### TECHNICAL FIELD

This application relates to the field of artificial intelligence (AI) technologies, and in particular, to a data processing method, system, and apparatus.

### BACKGROUND

Computational photography is a technology that integrates computer software methods (computer vision, digital signal processing, graphics, and the like) with photographic equipment and related applications. Computational photography combines hardware design with software computing capabilities, greatly simplifying a photography process and improving photography experience, and allowing more people to enj oy the fun of photography.

To obtain good image effect by using a terminal device (a mobile phone, a tablet computer, or the like), a RAW-RGB dataset including RAW data (all grayscale data of an image recorded by a photosensitive element) generated by the terminal device in a photographing process and RGB data (red, green, and blue color data) generated by a single-lens reflex camera may be used for neural network learning, to improve a photographing capability of the terminal device. However, it takes a long time to collect the RAW-RGB dataset, and the collected RAW-RGB dataset differs greatly from actual data.

Considering the problem that occurs during data collection, a related technology proposes to construct a RAW-RGB dataset by degrading RGB data into RAW data. However, in this manner, values of a plurality of parameters required for degrading RGB data into RAW data need to be manually calculated, and this manner is time-consuming and labor-consuming.

### SUMMARY

Based on this, this application provides a data processing method, system, and apparatus, to improve data processing efficiency.

According to a first aspect, this application provides a data processing method. The data processing method may be performed by a server, or may be performed by a device having a data processing function. This is not specifically limited herein. When the method is being executed, reference data needs to be obtained first, where the reference data includes RGB image data and a device parameter of an image device; then a plurality of conversion parameters required for converting the RGB image data into RAW data are determined; and finally, the RGB image data is processed into the RAW data based on the plurality of conversion parameters, where the RAW data matches the device parameter of the image device.

The image device may be understood as a device having an image processing function, and may be a terminal device such as a mobile phone, a tablet computer, or a mobile robot, or may be another device. This is not specifically limited herein in this application. In this application, the RGB image data is converted into the RAW data by using the conversion parameters, and the RGB image data is converted into the RAW data based on the conversion parameters. The RAW data obtained in this manner can improve data processing efficiency, and the RAW data matches the device parameter of the image device, thereby better adapting to a device requirement of the image device.

In a possible embodiment, the plurality of conversion parameters required for converting the RGB image data into the RAW data are determined through automated machine learning AutoML). In this application, the plurality of conversion parameters required for converting the RGB image data into the RAW data are determined through AutoML, and the RGB image data is converted into the RAW data based on the conversion parameters. The RAW data obtained in this manner can improve data processing efficiency, and the RAW data matches the device parameter of the image device, thereby better adapting to a device requirement of the image device.

In a possible embodiment, search space corresponding to the image device may be determined based on the device parameter, and then the plurality of conversion parameters are determined from the search space.

It should be noted that device parameters of different image devices are different. In this application, the search space that adapts to the requirement of the image device may be determined based on device parameters of different image devices, and the conversion parameters that adapt to the requirement of the image device are determined in the determined search space. The conversion parameters determined in this manner can improve efficiency of obtaining the conversion parameters, and the conversion parameters adapt to the requirement of the image device, thereby better converting the RGB image data into the RAW data.

In a possible embodiment, an image pair of the RGB image data and the RAW data may be constructed. Then, the image pair is input into a task processing unit for training, to determine a feedback signal. The task processing unit is configured to process video or image data. The feedback signal indicates construction quality of the image pair. Finally, the plurality of conversion parameters required for converting the RGB image data into the RAW data are updated based on the feedback signal.

It should be noted that the foregoing construction quality reflects a degree of matching between the RAW data and the device parameter of the image device when the RGB image data is converted into the RAW data. In this application, the plurality of conversion parameters required for converting the RGB image data into the RAW data are adjusted based on the feedback signal, so that accuracy of the conversion parameters can be converted, so that the RAW data better adapts to a requirement of the device parameter of the image device.

In a possible embodiment, the search space corresponding to the image device includes a plurality of image processing modules, and the image processing modules include one or more of the following: a noise addition module, a mosaic addition module, and a brightness adjustment module.

It should be noted that, the image processing modules in this application are not limited to the noise addition module, the mosaic addition module, and the brightness adjustment module, and may further include a level adjustment module, a white balance adjustment module, and the like. In addition, other image processing modules required for converting RGB image data into RAW data are all applicable to this application. A quantity and types of image processing modules specifically included are not specifically limited herein in this application.

In a possible embodiment, the conversion parameters include one or more of the following: a noise addition parameter, a mosaic addition parameter, a brightness adjustment parameter, a gamma parameter, a level adjustment parameter, and a white balance adjustment parameter.

It should be noted that the conversion parameters in this application are not limited to the noise addition parameter, the mosaic addition parameter, the brightness adjustment parameter, the gamma parameter, the level adjustment parameter, and the white balance adjustment parameter, and may further include a bad point correction parameter and the like. In addition, other conversion parameters required for converting RGB image data into RAW data are all applicable to this application. A quantity and types of the specifically included conversion parameters are not specifically limited herein in this application.

According to a second aspect, this application provides a data processing system, including an image degradation unit and a policy unit. The image degradation unit is configured to convert, based on a plurality of conversion parameters output by the policy unit, RGB image data into RAW data that matches a device parameter of an image device. The policy unit is configured to determine the plurality of conversion parameters required for converting the RGB image data into the RAW data.

It should be noted that in actual application, the image degradation unit and the policy unit may be understood as an image degradation apparatus and a policy apparatus, or may be understood as an image degradation model and a policy model. This is not specifically limited herein in this application. In this application, the image degradation unit may convert, based on the conversion parameters output by the policy unit, the RGB image data into the plurality of conversion parameters required for the RAW data, and the image degradation unit may convert the RGB image data into the RAW data based on the conversion parameters. The RAW data obtained by the data processing system can improve data processing efficiency, and the RAW data matches the device parameter of the image device, thereby better adapting to a device requirement of the image device.

In a possible embodiment, the policy unit is configured to determine, through automated machine learning AutoML, the plurality of conversion parameters required for converting the RGB image data into the RAW data.

In a possible embodiment, the image degradation unit is further configured to output an image pair of the RGB image data and the RAW data.

In a possible embodiment, the data processing system further includes a task processing unit. The task processing unit is configured to: perform training based on the image pair of the RGB image data and the RAW data that is output by the image degradation unit, determine a feedback signal, and input the feedback signal into the policy unit, where the feedback signal indicates construction quality of the image pair.

In a possible embodiment, the policy unit is further configured to: receive the feedback signal output by the task processing unit, adjust a network parameter of the policy unit based on the feedback signal, and update the plurality of conversion parameters based on the adjusted network parameter.

It should be noted that, in this application, the feedback signal indicates construction quality of the generated image pair of the RGB image data and the RAW data. The network parameter is adjusted based on the feedback signal, and the plurality of conversion parameters required for converting the RGB image data into the RAW data are updated based on the adjusted network parameter, so that the RAW data can better adapt to a requirement of the device parameter of the image device.

In a possible embodiment, the policy unit is further configured to: determine, based on the device parameter, search space corresponding to the image device; and determine the plurality of conversion parameters from the search space.

It should be noted that device parameters of different image devices are different. In this application, the search space that adapts to the requirement of the image device may be determined based on device parameters of different image devices, and the conversion parameters that adapt to the requirement of the image device are determined in the determined search space. The conversion parameters determined in this manner can improve efficiency of obtaining the conversion parameters, and the conversion parameters adapt to the requirement of the image device, thereby better converting the RGB image data into the RAW data.

In a possible embodiment, the image degradation unit includes a plurality of image processing modules, and the image processing modules include one or more of the following: a noise addition module, a mosaic addition module, and a brightness adjustment module.

It should be noted that, the image processing modules in this application are not limited to the noise addition module, the mosaic addition module, and the brightness adjustment module, and may further include a level adjustment module, a white balance adjustment module, and the like. In addition, other image processing modules required for converting RGB image data into RAW data are all applicable to this application. A quantity and types of image processing modules specifically included are not specifically limited herein in this application.

In a possible embodiment, the conversion parameters include one or more of the following: a noise addition parameter, a mosaic addition parameter, a brightness adjustment parameter, a gamma parameter, a level adjustment parameter, and a white balance adjustment parameter.

It should be noted that the conversion parameters in this application are not limited to the noise addition parameter, the mosaic addition parameter, the brightness adjustment parameter, the gamma parameter, the level adjustment parameter, and the white balance adjustment parameter, and may further include a bad point correction parameter and the like. In addition, other conversion parameters required for converting RGB image data into RAW data are all applicable to this application. A quantity and types of the specifically included conversion parameters are not specifically limited herein in this application.

According to a third aspect, this application provides a data processing apparatus, including a processor and a memory. The memory stores a computer program, and the processor is configured to execute the computer program stored in the memory, so that the solution according to any one of the embodiments of the first aspect is performed.

According to a fourth aspect, this application provides a computer-readable storage medium. The computer-readable storage medium stores computer-readable instructions, and when a computer reads and executes the computer-readable instructions, the computer is enabled to perform the solution according to any embodiment of the first aspect.

According to a fifth aspect, this application provides a computer program product. When a computer reads and executes the computer program product, the computer is enabled to perform the solution according to any embodiment of the first aspect.

For technical effects that can be achieved in the second aspect to the fifth aspect, refer to descriptions of the technical effects that can be achieved in the corresponding possible design solutions in the first aspect. Details are not described herein again in this application.

### BRIEF DESCRIPTION OF DRAWINGS

FIG. 1 is a schematic diagram of a structure of a data processing network according to an embodiment of this application;

FIG. 2 is a schematic diagram of a structure of an image degradation unit according to an embodiment of this application;

FIG. 3 is a schematic diagram of a structure of another data processing network according to an embodiment of this application;

FIG. 4 is a schematic flowchart of a data processing method according to an embodiment of this application; and

FIG. 5 is a schematic diagram of a structure of a data processing apparatus according to an embodiment of this application.

### DESCRIPTION OF EMBODIMENTS

To make objectives, technical solutions, and advantages of this application clearer, the following describes technical solutions in embodiments of this application in detail with reference to the accompanying drawings in embodiments of this application.

As described in the background, although a related technology proposes to construct a RAW-RGB dataset by degrading RGB data into RAW data, in this manner, values of a plurality of parameters required for degrading the RGB data into the RAW data need to be manually calculated. For example, to degrade RGB data into RAW data, image processing operations such as noise addition and mosaic addition need to be performed. It is assumed that there are 100 parameters related to noise addition and 200 parameters related to mosaic addition. In this case, a maximum quantity of attempts to determine parameter values required for degrading the RGB data into the RAW data is 20,000 (100 × 200). This method is time-consuming and labor-consuming, and the RAW data generated in this method may not meet device requirements of different image devices. Therefore, a data processing method is urgently required to resolve the foregoing problem.

It should be noted that, in this application, “and/or” describes an association relationship for describing associated objects and represents that three relationships may exist. For example, A and/or B may represent the following cases: Only A exists, both A and B exist, and only B exists, where A and B may be singular or plural. In addition, unless otherwise stated, ordinal numbers such as “first” and “second” in embodiments of this application are for distinguishing between a plurality of objects, but are not intended to limit an order, a time sequence, priorities, or importance of the plurality of objects.

Reference to “an embodiment”, “some embodiments”, or the like described in the specification of this application indicates that one or more embodiments of this application include a specific feature, structure, or characteristic described with reference to those embodiments. Therefore, in this specification, statements, such as “in an embodiment”, “in some embodiments”, “in some other embodiments”, and “in other embodiments”, that appear at different places do not necessarily mean reference to the same embodiment, but mean reference to “one or more but not all embodiments”, and mean reference to a specific feature, structure, or characteristic described with reference to the embodiment.

To better describe the solutions of this application, some professional terms in this application are first briefly described. Details are as follows:

AutoML: AutoML is a process of applying machine learning to automatic data processing of real problems. In actual applications, different parameters for different requirements can be provided for users based on different tasks. For example, if a task is to search for prime numbers in 1000 natural numbers, and the 1000 natural numbers and the task of searching for prime numbers are used as input data of AutoML, all prime numbers in the 1000 natural numbers may be output. If a task is to classify 10,000 images based on portraits, natural landscapes, and humanistic landscapes, and the 10,000 images are used as input data of AutoML, images may be output based on different categories.

RGB image: An RGB image includes a three-dimensional array in a format of M x N x 3, where “3” may be understood as three M x N two-dimensional images (grayscale value images). The three images represent R, G, and B components respectively. A pixel value range of each component is [0, 255]. R stands for Red (red), G stands for Green (green), and B stands for Blue (blue). When a computer defines a color, a value range of each of R, G, and B is 0 to 255. The value 0 indicates that there is no stimulation, and the value 255 indicates that the stimulation reaches a maximum value. When R, G, and B are all 255, white light is synthesized. When R, G, and B are all 0, black is formed.

RAW data: RAW data may be understood as a file that records original information of a sensor of an image device and some metadata (such as a sensitivity setting, a shutter speed, an aperture value, and a white balance) generated during photographing by the image device.

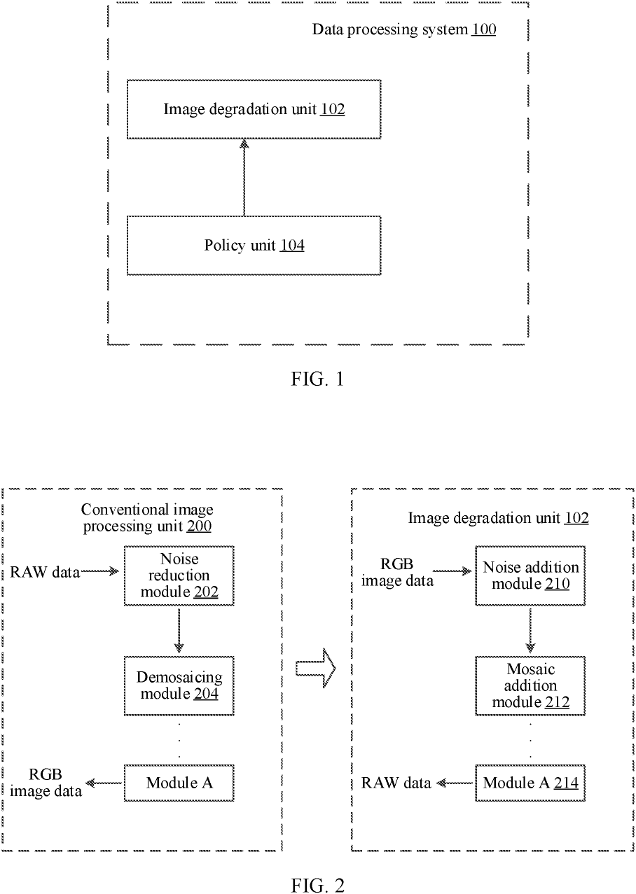

FIG. 1 is a schematic diagram of a data processing system 100 according to this application. The data processing system 100 includes an image degradation unit 102 and a policy unit 104. The data processing system 100 may be integrated into one device, or may be integrated into a plurality of devices. If the data processing system 100 is integrated into one device, the image degradation unit 102 may be an image degradation model, and the policy unit 104 may be a model configured to output a policy. If the data processing system 100 is integrated into a plurality of devices, the image degradation unit 102 may be a processing device configured to process image degradation data, and the policy unit 104 may be a processing device configured to output an image processing policy. Whether the unit is a model or a device is not specifically limited herein in this application.

It should be noted that the policy unit 104 may determine a plurality of conversion parameters required for converting RGB image data into RAW data, for example, determine, through AutoML, the plurality of conversion parameters required for converting the RGB image data into the RAW data. The image degradation unit 102 may receive the RGB image data and a device parameter of an image device, and convert, based on the plurality of conversion parameters output by the policy unit, the RGB image data into the RAW data that matches the device parameter of the image device. The image device may be understood as a device having an image processing function, and may be a terminal device such as a mobile phone, a tablet computer, or a mobile robot, or may be another device. This is not specifically limited herein in this application. The RGB image data may be an image directly downloaded by the data processing system 100 from a network, or may be an image that is shot by a single-lens reflex camera and then imported into the data processing system 100, or may be an image that is downloaded by the image device from a network and then transmitted to the data processing system. A data source of the RGB image data is not specifically limited herein in this application.

In this application, the plurality of conversion parameters required for converting the RGB image data into the RAW data are determined through AutoML, and the RGB image data is converted into the RAW data based on the conversion parameters. The RAW data obtained in this manner can improve data processing efficiency. In addition, the RAW data determined in this application matches the device parameter of the image device, and therefore better adapts to a device requirement of the image device.

In addition, the policy unit 104 in this application may further determine, based on the device parameter, search space corresponding to the image device, and determine the plurality of conversion parameters from the search space. The conversion parameters determined by the policy unit can adaptively adapt to a requirement of the device parameter of the image device. For example, in device parameters of an image device 1, a sensitivity is a parameter 1, and an aperture value is a parameter 2. A server may determine, based on the parameter 1 and the parameter 2, search space 1 that adapts to the image device 1, and determine, in the search space 1, a plurality of conversion parameters that adapt to a requirement of the image device 1. For example, in device parameters of an image device 2, a sensitivity is a parameter 2, an aperture value is a parameter 4, and a shutter speed is a parameter 3. In this case, the server may determine, based on the parameter 1, the parameter 2, and the parameter 3, search space 2 that adapts to the image device 2, and determine, in the search space 2, a plurality of conversion parameters that adapt to a requirement of the image device 2.

In addition, the image degradation unit 102 may include a plurality of image processing modules. The image processing modules may include one or more of the following: a noise addition module, a mosaic addition module, and a brightness adjustment module. The conversion parameters may include one or more of the following: a noise addition parameter, a mosaic addition parameter, a brightness adjustment parameter, a gamma parameter, a level adjustment parameter, and a white balance adjustment parameter.

It should be noted that, because the image degradation unit 102 in this application converts RGB image data into RAW data, that is, changes a high-definition image into a low-definition image, an image processing procedure such as noise addition, mosaic addition, and brightness adjustment needs to be performed. However, in actual application, image processing modules may not be limited to the foregoing several image processing modules, and may further include other image processing modules. All image processing modules that may be involved in the process of converting RGB image data into RAW data are applicable to this application, and are not shown one by one in this application.

In addition, conversion parameters that match the image processing module may include a noise addition parameter, a mosaic addition parameter, a brightness adjustment (for example, brightness increasing or brightness decreasing) parameter, a gamma parameter, a level adjustment (for example, black level adding or white level adding) parameter, and a white balance adjustment parameter. Noise may include white Gaussian noise, additive noise, and multiplicative noise. The gamma parameter may be used for grayscale adjustment and transparency adjustment. White balance may be used to eliminate impact of a light source on an image, for example, increase impact of a light source on an image by adjusting the white balance adjustment parameter. All conversion parameters that may be involved in a process of converting the RGB image data into the RAW data are applicable to this application, and are not shown one by one in this application.

It should be noted that the search space is related to the image processing modules in the image degradation unit 102 and the parameters (the parameters match the device parameter of the image device) corresponding to the image processing modules in the image degradation unit 102. As shown in FIG. 2, a conventional image processing procedure performed by a conventional image processing unit 200 is to remove noise from RAW data by using a noise reduction module 202, remove mosaics from the RAW data by using a demosaicing module 204, and convert the RAW data into RGB image data. In the image degradation processing in this application, noise is added to RGB image data by using a noise addition module 210, mosaics are added to the RGB image data by using a mosaic addition module 212, and the RGB image data is converted into RAW data. Image processing such as noise addition and mosaic addition is performed on the RGB image data (that is, an image processing operation opposite to that of converting RAW data into RGB image data). In actual application, the image degradation unit 102 may further include other image processing modules (a module A 214 is used as an example in FIG. 2), which are not shown one by one herein. The search space mentioned in this application is related to the image processing modules in the image degradation unit. For example, an image degradation unit 102 adapted to an image device 1 includes three image processing modules: a noise addition module 210, a mosaic addition module 212, and a brightness adjustment module (e.g., an example of module A 214). In this case, search space adapted to the image device 1 may be determined by using a policy unit 104, and the search space includes a parameter corresponding to the noise addition module 210, the mosaic addition module 212, and the brightness adjustment module. In addition, there may be a plurality of conversion parameters corresponding to the noise addition module 210, the mosaic addition module 212, and the brightness adjustment module. Value ranges of the conversion parameters corresponding to the noise addition module 210, the mosaic addition module 212, and the brightness adjustment module may be determined based on the device parameter of the image device. For example, an aperture value of the image device 1 is A. The policy unit 104 learns, based on the aperture value A, that a value range of a conversion parameter corresponding to the brightness adjustment module is 50 to 500, and is not 0 to infinity. Therefore, a parameter search range of the policy unit may be narrowed. A relationship between a parameter of another image processing module and a parameter of an image device is not described herein in this application.

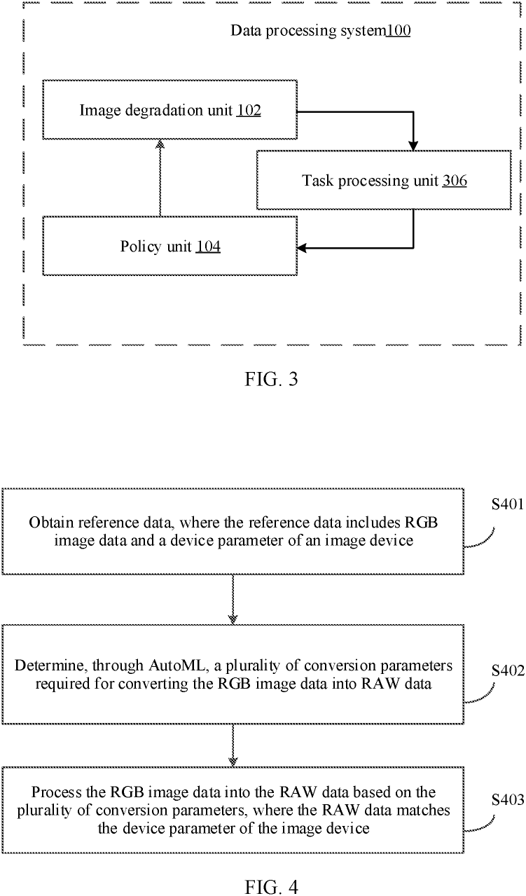

In an example, the data processing system 100 may further include a task processing unit 306. As shown in FIG. 3, the task processing unit 306 may perform training based on an image pair of the RGB image data and the RAW data that is output by the image degradation unit 102, determine a feedback signal, and input the feedback signal into the policy unit 104, so that the policy unit 104 adjusts a network parameter of the policy unit 104 based on the feedback signal, and updates the plurality of conversion parameters based on the adjusted network parameter. It should be noted that the policy unit 104 may be understood as a neural network model. When the network model is being constructed, a large quantity of network parameters related to a model structure are required. An output policy of the policy unit 104 may be adjusted by adjusting the network parameter, so as to adjust the plurality of conversion parameters output by the policy unit 104. The feedback signal indicates construction quality of the generated image pair, and the feedback signal may be indicated by using a loss value of a test data set or a training data set. The construction quality reflects a degree of matching between the RAW data and the device parameter of the image device when the RGB image data is converted into the RAW data. The task processing unit 306 may be configured to process video or image data, for example, convert a low-resolution video into an ultra-high-definition video, convert a low-resolution image into a high-resolution image, or convert a low-luminance image into a high-luminance image. This is not specifically limited in this application.

For example, the image pair of the RGB image data and the RAW data is input into the task processing unit 306 for training, to obtain the feedback signal, and the feedback signal is input into the policy unit 104. The policy unit 104 adaptively adjusts, based on the feedback signal, the conversion parameters to be output by the policy unit 104, and inputs the conversion parameters into the image degradation unit 102 to degrade the RGB image data into the RAW data. Cyclic iteration is continuously performed, until construction quality of the image pair indicated by the feedback signal meets a preset requirement. A quantity of times of iterations may be a preset value specified based on a user requirement, for example, 500. After 500 times of iteration, iteration is not performed regardless of a value of the feedback signal. Conversion parameters determined by the policy unit 104 in the 500^{th} time of iteration are used as conversion parameters required by the image degradation unit 102, and RGB image data obtained by a data processing network is converted into RAW data based on the conversion parameters, that is, the conversion parameters determined in the last iteration are used as final conversion parameters. Alternatively, different conversion parameters updated based on the feedback signal in a search process of the policy unit 104 may be used as final parameters. For example, when a loss value of a verification dataset is used as the feedback signal, a conversion parameter corresponding to a smallest loss value of the verification dataset may be selected as a final parameter.

In addition, it should be further noted that, in this application, the policy unit 102 may determine the conversion parameters by using a network such as a long short-term memory (LSTM) network or a recurrent neural network ( RNN). This is not specifically limited in this application. Any network that can determine the conversion parameters based on AutoML is applicable to this application.

The following describes a data processing method used in this application. The data processing method may be performed in the foregoing data processing network, or may be performed in a server or a data processing device having a data processing function. An execution body of the data processing method is not specifically limited herein in this application. In actual application, a conversion parameter for converting RGB image data into RAW data may be determined in another manner, for example, machine learning, deep learning, or AutoML. FIG. 4 uses only AutoML as an example for description. FIG. 4 is described by using an example in which the execution body is a server. The server may perform the following operations with reference to FIG. 4.

Operation 401: Obtain reference data, where the reference data includes RGB image data and a device parameter of an image device.

Operation 402: Determine, through AutoML, a plurality of conversion parameters required for converting the RGB image data into RAW data.

Operation 403: Process the RGB image data into the RAW data based on the plurality of conversion parameters, where the RAW data matches the device parameter of the image device.

In this application, the plurality of conversion parameters required for converting the RGB image data into the RAW data are determined through AutoML, and the RGB image data is converted into the RAW data based on the conversion parameters. The RAW data obtained in this manner can improve data processing efficiency, and the RAW data matches the device parameter of the image device, thereby better adapting to a device requirement of the image device.

For example, the server may further determine, based on the device parameter, search space corresponding to the image device, and then determine the plurality of conversion parameters from the search space.

It should be noted that device parameters of different image devices are different. In this application, the search space that adapts to the requirement of the image device may be determined based on the device parameters of the different image devices, and the conversion parameters that adapt to the requirement of the image device are determined in the determined search space. The conversion parameters determined in this manner can improve efficiency of obtaining the conversion parameters, and the conversion parameters adapt to the requirement of the image device, thereby better converting the RGB image data into the RAW data, for example, implementing a function of the policy unit 104 in the foregoing data processing network. Details are not described herein in this application.

For example, the server may further construct an image pair of the RGB image data and the RAW data; then input the image pair into a task processing unit 306 for training, to determine a feedback signal; and finally update, based on the feedback signal, the plurality of conversion parameters required for converting the RGB image data into the RAW data. The task processing unit 306 is configured to process video or image data, and the feedback signal indicates construction quality of the image pair.

It should be noted that, in this application, the feedback signal indicates construction quality of the generated image pair of the RGB image data and the RAW data. Adjusting, based on the feedback signal, the plurality of conversion parameters required for converting the RGB image data into the RAW data may convert accuracy of the parameters, so that the RAW data better adapts to a requirement of the device parameter of the image device.

For example, the search space corresponding to the image device includes a plurality of image processing modules. As shown in the foregoing description of the image degradation unit 102 in the data processing network, the image processing modules include one or more of the following: a noise addition module 210, a mosaic addition module 212, and one or more additional modules, such as a brightness adjustment module. Details are not described herein in this application.

For example, the conversion parameters include one or more of the following: a noise addition parameter, a mosaic addition parameter, a brightness adjustment parameter, a gamma parameter, a level adjustment parameter, and a white balance adjustment parameter, as shown in the foregoing description of the data processing network. Details are not described in this application again.

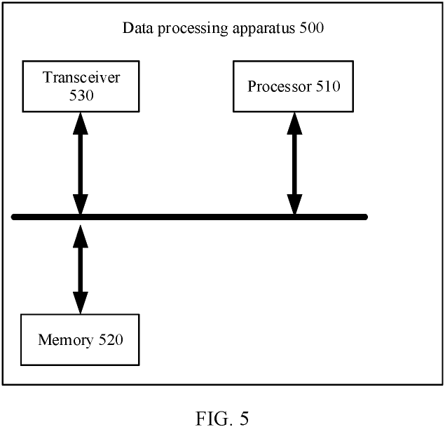

Based on a same concept, FIG. 5 shows a data processing apparatus 500 according to this application. For example, the data processing apparatus 500 may be a chip or a chip system. Optionally, in this embodiment of this application, the chip system may include a chip, or may include the chip and another discrete device.

The data processing apparatus 500 may include at least one processor 510, and the data processing apparatus 500 may further include at least one memory 520, configured to store a computer program, program instructions, and/or data. The memory 520 is coupled to the processor 510. The coupling in this embodiment of this application may be an indirect coupling or a communication connection between apparatuses, units, or modules in an electrical form, a mechanical form, or another form, and is used for information exchange between the apparatuses, the units, or the modules. The processor 510 may cooperate with the memory 520. The processor 510 may execute the computer program stored in the memory 520. Optionally, at least one of the at least one memory 520 may be included in the processor 510.

The data processing apparatus 500 may further include a transceiver 530, and the data processing apparatus 500 may exchange information with another device by using the transceiver 530. The transceiver 530 may be a circuit, a bus, a transceiver, or any other apparatus that may be configured to exchange information.

In a possible embodiment, the data processing apparatus 500 may be applied to the foregoing network device. Specifically, the fault analysis apparatus 500 may be the foregoing network device, or may be an apparatus that can support the foregoing network device in implementing any one of the foregoing embodiments. The memory 520 stores a necessary computer program, program instructions, and/or data for implementing the function of the network device in any one of the foregoing embodiments. The processor 510 may execute the computer program stored in the memory 520, to complete the method in any one of the foregoing embodiments.

In this embodiment of this application, a specific connection medium between the transceiver 530, the processor 510, and the memory 520 is not limited. In this embodiment of this application, the memory 520, the processor 510, and the transceiver 530 are connected by using a bus in FIG. 5. The bus is represented by a bold line in FIG. 5. A connection manner between other components is merely an example for description, and is not limited thereto. The bus may be classified into an address bus, a data bus, a control bus, and the like. For ease of representation, only one bold line is used to represent the bus in FIG. 5, but this does not mean that there is only one bus or only one type of bus.

In the embodiment of this application, the processor may be a general-purpose processor, a digital signal processor, an application-specific integrated circuit, a field programmable gate array or another programmable logic device, a discrete gate or transistor logic device, or a discrete hardware component, and may implement or execute the methods, operations, and logical block diagrams disclosed in the embodiments of this application. The general purpose processor may be a microprocessor or any conventional processor or the like. The operations of the method disclosed with reference to embodiments of this application may be directly performed by a hardware processor, or may be performed by using a combination of hardware in the processor and a software module.

In embodiments of this application, the memory may be a nonvolatile memory, for example, a hard disk drive (HDD) or a solid-state drive (SSD), or may be a volatile memory such as a random access memory (RAM). The memory may alternatively be any other medium that can be configured to carry or store expected program code in a form of an instruction or a data structure and that can be accessed by a computer. This is not limited thereto. The memory in the embodiment of this application may alternatively be a circuit or any other apparatus that can implement a storage function, and is configured to store the computer program, the program instruction, and/or the data.

Based on the foregoing embodiments, the embodiment of this application further provides a readable storage medium. The readable storage medium stores an instruction, and when the instruction is executed, the method performed by the security detection device in any one of the foregoing embodiments is implemented. The readable storage medium may include: any medium that can store program code, a USB flash drive, a removable hard disk, a read-only memory, a random access memory, a magnetic disk, or an optical disc.

A person skilled in the art should understand that the embodiments of this application may be provided as a method, a system, or a computer program product. Therefore, this application may use a form of hardware only embodiments, software only embodiments, or embodiments with a combination of software and hardware. In addition, this application may use a form of a computer program product that is implemented on one or more computer-usable storage media (including but not limited to a disk memory, a CD-ROM, an optical memory, and the like) that include computer-usable program code.

This application is described with reference to the flowcharts and/or block diagrams of the method, the device (or system), and the computer program product according to this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing apparatus to generate a machine, so that the instructions executed by a computer or a processor of any other programmable data processing apparatus generate an apparatus for implementing a specific function in one or more processes in the flowcharts and/or in one or more blocks in the block diagrams.

These computer program instructions may also be stored in a computer-readable memory that can instruct the computer or any other programmable data processing apparatus to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may also be loaded onto a computer or another programmable data processing apparatus, so that a series of operations and operations are performed on the computer or the another programmable apparatus, to generate computer-implemented processing. Therefore, the instructions executed on the computer or the another programmable apparatus provide operations for implementing a specific function in one or more processes in the flowcharts and/or in one or more blocks in the block diagrams.

1. A data processing method, comprising:
obtaining reference data that comprises RGB image data and a device parameter of an image device;
determining a plurality of conversion parameters for converting the RGB image data into RAW data; and
processing the RGB image data into the RAW data based on the plurality of conversion parameters, wherein the RAW data matches the device parameter of the image device.

2. The method according to claim 1, wherein the determining the plurality of conversion parameters for converting the RGB image data into the RAW data comprises:
determining, through automated machine learning (AutoML), the plurality of conversion parameters for converting the RGB image data into the RAW data.

3. The method according to claim 2, wherein the determining, through AutoML, the plurality of conversion parameters for converting the RGB image data into the RAW data comprises:
determining, based on the device parameter, a search space corresponding to the image device; and
determining the plurality of conversion parameters from the search space.

4. The method according to claim 1, further comprising:
constructing an image pair of the RGB image data and the RAW data;
inputting the image pair into a task processor for training, and determining a feedback signal, wherein the task processor is configured to process video or image data, and the feedback signal indicates construction quality of the image pair; and
updating, based on the feedback signal, the plurality of conversion parameters for converting the RGB image data into the RAW data.

5. The method according to claim 1, wherein the search space corresponding to the image device comprises a plurality of image processing modules; and
the image processing modules comprise one or more of the following: a noise addition module, a mosaic addition module, or a brightness adjustment module.

6. The method according to claim 1, wherein the conversion parameters comprise one or more of the following: a noise addition parameter, a mosaic addition parameter, a brightness adjustment parameter, a gamma parameter, a level adjustment parameter, and a white balance adjustment parameter.

7. A data processing system, comprising:
an image degradation unit configured to convert, based on a plurality of conversion parameters output by a policy unit, RGB image data into RAW data that matches a device parameter of an image device; and
the policy unit is configured to determine the plurality of conversion parameters for converting the RGB image data into the RAW data.

8. The system according to claim 7, wherein the policy unit is configured to determine, through automated machine learning (AutoML), the plurality of conversion parameters for converting the RGB image data into the RAW data.

9. The system according to claim 7, wherein the image degradation unit is further configured to:
output an image pair of the RGB image data and the RAW data.

10. The system according to claim 7, further comprising:
a task processing unit configured to: perform training on the image pair of the RGB image data and the RAW data that is output by the image degradation unit, determine a feedback signal, and input the feedback signal into the policy unit, wherein the feedback signal indicates construction quality of the image pair.

11. The system according to claim 7, wherein the policy unit is further configured to:
receive the feedback signal output by the task processing unit, and adjust a network parameter of the policy unit based on the feedback signal; and
update the plurality of conversion parameters based on the adjusted network parameter.

12. The system according to claim 7, wherein the policy unit is further configured to:
determine, based on the device parameter, a search space corresponding to the image device; and
determine the plurality of conversion parameters from the search space.

13. The system according to claim 7, wherein the image degradation unit comprises a plurality of image processing modules; and
the image processing modules comprise one or more of the following: a noise addition module, a mosaic addition module, and a brightness adjustment module.

14. The system according to claim 7, wherein the conversion parameters comprise one or more of the following: a noise addition parameter, a mosaic addition parameter, a brightness adjustment parameter, a gamma parameter, a level adjustment parameter, and a white balance adjustment parameter.

15. A data processing apparatus, comprising
a memory storing a computer program, and
a processor configured to execute the computer program stored in the memory causing the processor to perform the method according to claim 1.

16. A computer-readable storage medium, wherein the computer-readable storage medium stores computer instructions, and when the instructions are run on a computer, the computer performs the method according to claim 1.
